(19) United States
(12) Patent Application Publication
(10) Pub. No.: US 2006/0274759 A1
(43) Pub. Date: Dec. 7, 2006

(54) Method and system for SIP-based mobility management

(76) Inventor: Masahiro Maeda, Tokyo (JP)

Correspondence Address: MOTOROLA, INC., 1303 EAST ALGONQUIN ROAD, IL01/3RD, SCHAUMBURG, IL, 60196, US

(21) Appl. No.: 11/143,243

(22) Filed: Jun. 2, 2005

(51) Int. Cl. H04L 12/56

(52) U.S. Cl. 370/395.52; 370/338

(57) ABSTRACT

A method and system for establishing communication between a first Mobile Node (MN1) and a second Mobile Node (MN2) using Session Initiation Protocol (SIP)-based mobility management are useful for maintaining location privacy and separating IP transport and network control features. Where the MN1 is in communication with a first Access Router (AR1) and the MN2 is in communication with a second Access Router (AR2), the method includes receiving, from the AR1 acting as an SIP User Agent (UA), at a Routing Manager (RM) a first call initiation message including an Internet Protocol host address (IPha) of the MN2 (step 610). Next, a query is transmitted, which includes the IPha of the MN2, from the RM to a Location Manager (LM) acting as an SIP Registrar (step 615). The RM then receives from the LM, in response to the query, an Update message including an IP routing address (IPra) of the MN2 that is used to identify the AR2 (step 620). The RM then transmits to the AR2 a second call initiation message that includes the IPra of the MN2 (step 630).

### FIELD OF THE INVENTION

The present invention relates generally to a method and system for establishing communications between mobile nodes and to Session Initiation Protocol (SIP)-based mobility management.

### BACKGROUND OF THE INVENTION

Future wireless communication systems will provide a wide range of services using a variety of access technologies. Such systems are often described as Beyond 3G (B3G) systems and will include support for heterogeneous network access, communication service, user devices and mobility service. Modern networks are becoming increasingly diverse in their interconnectivity and transport capabilities, and B3G systems will need to be capable of managing even greater diversity. B3G systems may thus need to operate in an environment where almost all devices are networked, and almost all network entities are mobile.

Current trends in network technology also indicate that Internet technology will continue to dominate the future. Internet Protocol (IP) will likely remain the common method for transmitting data across a variety of networks. B3G systems will therefore operate between IP backbone networks and proprietary local environments.

One proposed B3G mobility management concept is the IP-based IMT Network platform (IP²). It is envisaged that IP² will enable advanced mobility management by separating mobility management functions from network transport functions. Existing Internet standards are based on a fixed network where an IP address is used both as a terminal identifier and as a routing address. IP² is intended to enable an entirely mobile IP environment where a terminal identifier of a mobile device does not need to be changed when the device changes location. In IP² it is planned that a terminal identifier will be used only to identify a mobile device, and a routing address will be used only to transport packets within a network.

It has been suggested that many of the routing methods and protocols for accomplishing the mobile IP environment of IP² will need to be fabricated and customized exclusively for such an IP² environment. However, developing entirely new methods and protocols is a difficult undertaking that requires additional expense, time, and educational initiatives for the user community, and that may fail to capture many of the advantages and features of existing methods and protocols.

### SUMMARY OF THE INVENTION

According to one aspect, the present invention is therefore a method for establishing communication between a first Mobile Node (MN1) and a second Mobile Node (MN2) using Session Initiation Protocol (SIP)-based mobility management, where the MN1 is in communication with a first Access Router (AR1) and the MN2 is in communication with a second Access Router (AR2). The method includes receiving, from the AR1 acting as an SIP User Agent (UA), at a Routing Manager (RM) a first call initiation message including an Internet Protocol host address (IPha) of the MN2. Next, a query is transmitted, which includes the IPha of the MN2, from the RM to a Location Manager (LM) acting as an SIP Registrar. The RM then receives from the LM, in response to the query, an Update message including an IP routing address (IPra) of the MN2 that is used to identify the AR2. The RM then transmits to the AR2 a second call initiation message that includes the IPra of the MN2. The present invention thus supports location privacy by preventing IPras from reaching end users, and also saves significant development resources and time by adapting an existing protocol to the core network part of an IP² system.

According to another aspect, the present invention is A Network Control Platform (NCPF) system for establishing communication between a MN1 and a MN2 using SIP-based mobility management. The system includes a RM adapted to receive a first call initiation message from a AR1, which AR1 acts as an SIP User Agent in communication with the MN1, the message including an IPha of the MN2. The system also includes a LM acting as an SIP Registrar and adapted to receive a query from the RM, the query including the IPha of the MN2, where the LM is further adapted to transmit to the RM, in response to the query, an IP routing address (IPra) of the MN2 that is used to identify the AR2.

### BRIEF DESCRIPTION OF THE DRAWINGS

In order that the invention may be readily understood and put into practical effect, reference will now be made to exemplary embodiments as illustrated with reference to the accompanying figures, wherein like reference numbers refer to identical or functionally similar elements throughout the separate views. The figures together with a detailed description below, are incorporated in and form part of the specification, and serve to further illustrate the embodiments and explain various principles and advantages, in accordance with the present invention, where:

FIG. 1 is a schematic diagram illustrating the basic components of an IP² system according to the prior art;

FIG. 2 is a schematic diagram of a system according to an embodiment of the present invention that separates a mobility management protocol into two primary components;

FIG. 3 is a message sequence chart that illustrates specific message sequences used to establish communications between a MN1 and a MN2 in a system according to an embodiment of the present invention;

FIG. 4 is a message sequence chart that illustrates specific message sequences used to establish communications between a MN1 and a MN2 in a system according to another embodiment of the present invention;

FIG. 5 is a message sequence chart illustrating a process of registering a MN1 with a NCPF according to an embodiment of the present invention; and

FIG. 6 is a general flow diagram illustrating a method for establishing communication between an MN1 and an MN2 using SIP-based mobility management according to an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Before describing in detail embodiments that are in accordance with the present invention, it should be observed that the embodiments reside primarily in combinations of method steps and apparatus components related to establishing communications between mobile nodes and to Session Initiation Protocol (SIP)-based mobility management. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

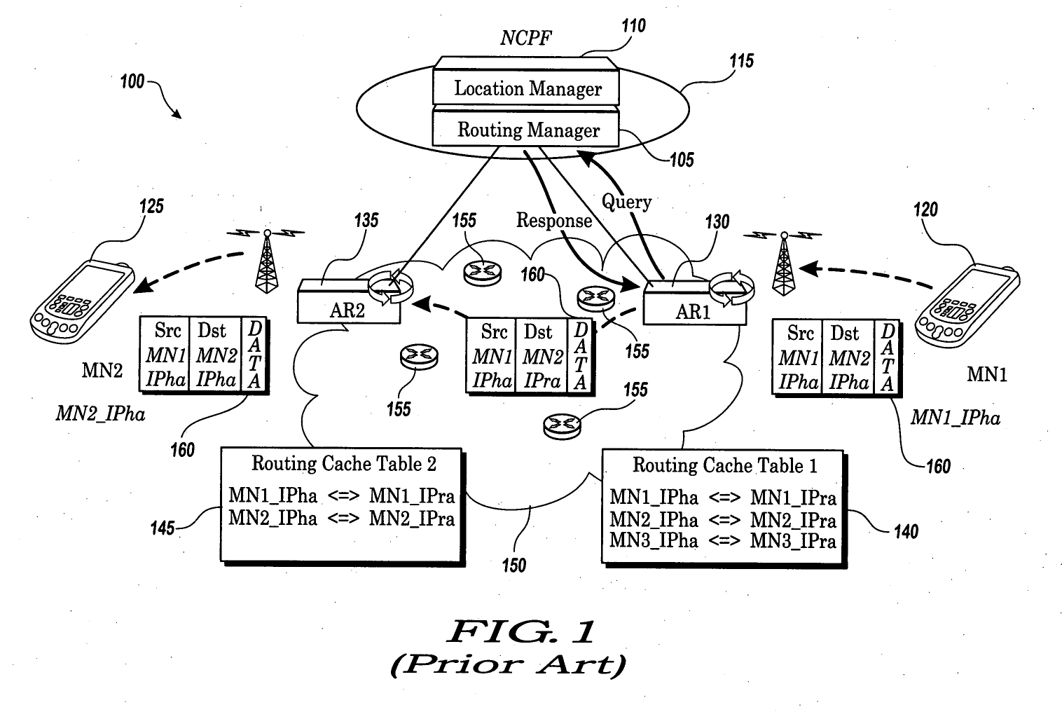

Referring to FIG. 1 there is a schematic diagram illustrating the basic components of an IP² system 100 according to the prior art. The system 100 includes a Routing Manager (RM) 105 and a Location Manager (LM) 110 in a Network Control Platform (NCPF) 115. The RM 105 and the LM 110 manage routing information and location information separately to improve network security. Also, the RM 105 and the LM 110 cannot be accessed directly by devices such as Mobile Nodes (MNs) MN1 120 and MN2 125, which adds further security concerning the location information of the MNs 120, 125. Instead, the RM 105 and the LM 110 are reached by a MN 120, 125 using intermediate Access Routers (ARs) AR1 130 and AR2 135. The ARs 130, 135 reside in an IP Back Bone (IP-BB) network 150 among various Internet routers 155. The MNs 120, 125 may include for example mobile phones, personal digital assistants (PDAs), laptop computers, and other wireless devices.

The ARs 130, 135 include Routing Cache Tables (RCTs) RCT1 140 and RCT2 145 that list a unique correspondence for each MN 120, 125 between an IP host address (IPha) and an IP routing address (IPra). It is planned that when the MN1 120 first registers with the NCPF 115, the AR1 130 assigns an IPra to the MN1 120 by establishing in the RCT1 140 correspondence between the IPha and the IPra of the MN1 120.

Using methods and protocols that have not yet been invented, the prior art envisages that when a data packet 160 is transferred from the MN1 120 to the MN2 125, the MN1 120 will first transmit the packet to the AR1 130 and attach to the packet 160 in an IP header a source identifier that is the IPha of the MN1 120, and a destination identifier which is the IPha of the MN2 125. Through a query and response mechanism using the IPha of the MN2 125, the AR1 130 will then obtain from the NCPF 115 the IPra of the MN2 125. The data packet 160 is then transmitted from the AR1 130 across the IP-BB 150 to the AR2 135; but the IPra, instead of the IPha, of the MN2 125 is now used as the destination identifier. After the data packet 160 is received by the AR2 135, the packet 160 is finally transmitted from the AR2 135 to the MN2 125, but again including only the IPha of the MN1 120 as a source identifier and the IPha of the MN2 125 as the destination identifier in an IP header. In such a manner the location information of the MN1 120 and the MN2 125 that is included in the IPras is never transmitted to another mobile node, where it could be subject to improper use; instead the location information is securely retained within the AR1 130 and the AR2 135. However, according to the prior art no packet formats, fall-back procedures, or protocols between the LM 110 and the RM 105 have been developed to implement the above described procedures of an IP system.

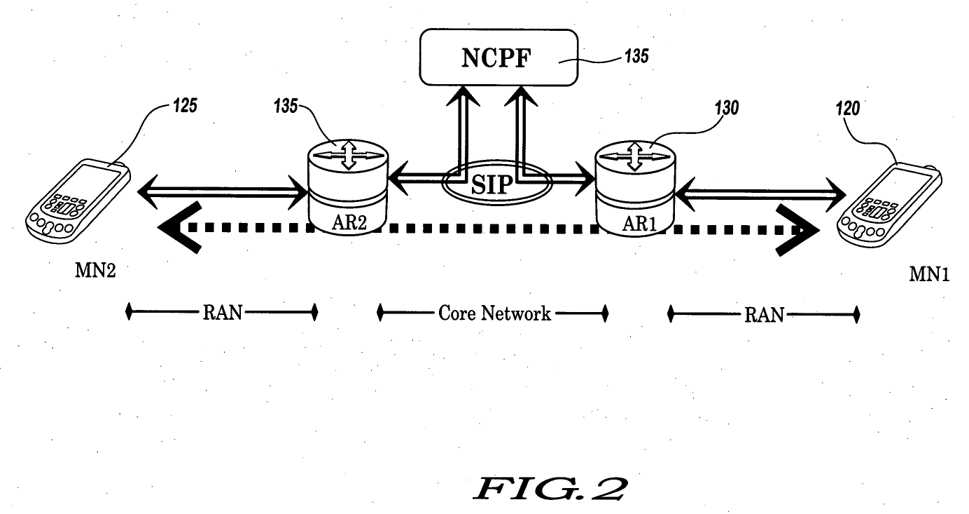

An embodiment of the present invention is therefore a specific method and system for establishing communications between a MN1 120 and a MN2 125 in an IP² environment. Referring to FIG. 2 there is a schematic diagram of a system 200 according to an embodiment of the present invention that separates a mobility management protocol into two parts: first, a Radio Access Network (RAN) part that provides communications between MNs 120, 125 and ARs 130, 135; and second, a core network part that provides communications between the ARs 130, 135 and an NCPF 115 using Session Initiation Protocol (SIP)-based techniques. Embodiments of the present invention convert an IP² RM 105 into an SIP Controller, an IP² LM 110 into an SIP Registrar, and an IP² AR 120, 125 into an SIP User Agent (UA). ARs 130, 135 exchange routing cache information by sending or receiving SIP messages that contain an IPha, IPra, or both, concerning a source or destination MN 120, 125. The ARs 130, 135 then modify RCTs 140, 145 based on received messages.

The present invention thus supports location privacy, which is a primary objective of IP² concepts, by preventing IPras from reaching end users. The invention also saves significant development resources and time by adapting an existing protocol to the core network part of an IP² system.

SIP-based mobility management according to the present invention is efficient because it reuses several SIP schemes, including those concerning message formatting, retransmission mechanisms, and server software. The SIP-based methods and systems of the present invention are also desirable because SIP is an extensible text-based messaging protocol that can integrate Authentication, Authorization and Accounting (AAA) features, Quality of Service (QoS) features, and security negotiation features.

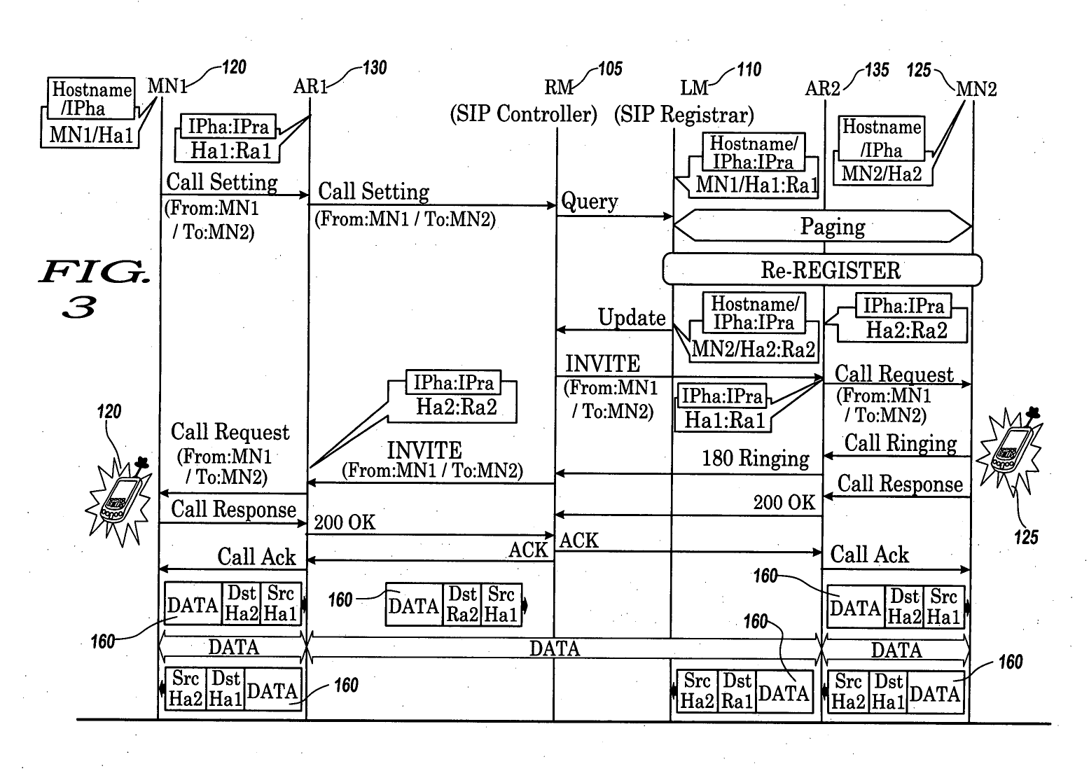

Referring to FIG. 3 there is a message sequence chart that illustrates specific message sequences used to establish communications between a MN1 120 and a MN2 125 in a system 200 according to an embodiment of the present invention. According to the embodiment shown in FIG. 3, a RM 105 acts as an SIP Controller and sets up sessions with both an AR1 130 and an AR2 135 using a non-SIP message from the MN1 120 as a trigger.

First, where the MN1 120 acts as a caller and intends to initiate communications with the MN2 125 as a callee, the MN1 120 transmits to the AR1 130 a Call Setting message including the IPha of the MN1 120 and the IPha of the MN2 125. The AR1 130 then forwards the Call Setting message to the RM 105 and includes both the IPha and IPra of the MN1 120 and the IPha of the MN2 125. The RM 105 then begins to setup an SIP session with the AR2 135, although the RM 105 still does not know the location of the MN2 125. The RM 105 therefore transmits a Query message to the LM 110 so as to identify the current location of the MN2 125. Next, the LM 110 finds the location of the MN2 125 by searching for the IPra of the MN2 125 in a database of the LM 110, by a paging method, or by some other type of method. After the MN2's 125 location is identified, the LM 110 transmits to the RM 105 an Update message including the IPra of the MN2 125. Those skilled in the art will recognize that the Query and Update messages can be realized using an SIP Invite request and an SIP 302 Temporary moved response, respectively, or using other proprietary messages.

After the RM 105 receives the IPra of the MN2 125, the RM 105 sends an SIP Invite request message that identifies the IPra of the MN2 125 and which is routed to the AR2 135. The Invite message includes the IPha and the IPra of both the MN1 120 and the MN2 125. The AR2 135 then translates the received Invite message to a proprietary message called a Call Request and sends it to the MN2 125. The AR2 135 also creates a routing cache entry in an RCT2 135 that records the IPha and IPra of the MN1 120 for use in future address conversions.

When the MN2 125 receives the Call Request message it notifies a user of the MN2 125 of a call arrival, such as through a ring tone or vibration, and sends a Call Ringing message to the AR2 135. The AR2 135 then sends an SIP 180 ringing status message to the to the RM 105.

When MN2 125 accepts the call, the MN2 125 sends a Call Response message to the AR2 135. The AR2 135 then transmits an SIP 200 OK message to the RM 105. After the RM 105 receives an SIP 180 ringing message or an SIP 200 OK message from the AR2 135, the RM 105 initiates an SIP session with the AR1 130. That is done by sending an SIP Invite message from the RM 105 to the AR1 130, which message includes the IPha and IPra of the MN2 125 and the IPra of the MN1 120. The AR1 130 then translates the received Invite message to a proprietary Call Request message and sends it to the MN1 120. The AR1 130 also creates a routing cache entry in an RCT2 140 that records the IPha and IPra of the MN2 125 for future address conversions. The MN1 120 then sends back a Call Response message to the AR1 130 and the AR1 130 sends an SIP 200 OK message to the RM 105. When the RM 105 receives the 200 OK messages from both the AR1 130 and the AR2 135, the RM 105 sends SIP ACK messages to both the AR1 130 and the AR2 135. The AR1 130 and the AR2 135 then transmit Call Ack messages to the MN1 120 and the MN2 125, respectively. Finally, the MN1 120 and the MN2 125 commence data transmission between each other through the AR1 130 and the AR2 135. Both the MN1 120 and the MN2 125 use the IPha addresses as source/destination addresses. As described above, the destination address of an IP header in a data packet 160 is translated from an IPha to an IPra at ingress to an AR 130, 135 and then translated back from an IPra to an IPha at egress from an AR 130, 135.

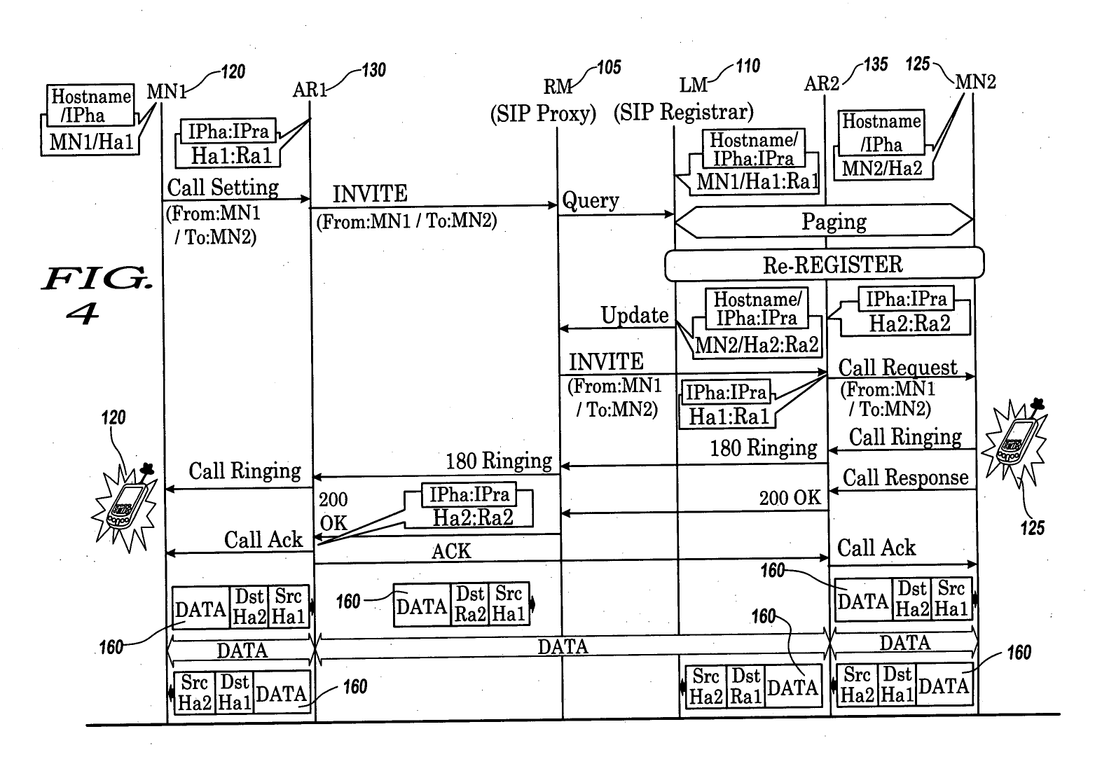

Referring to FIG. 4 there is a message sequence chart that illustrates specific message sequences used to establish communications between a MN1 120 and a MN2 125 in a system 200 according to another embodiment of the present invention. According to the embodiment shown in FIG. 4, a RM 105 acts as an SIP Proxy and relays SIP messages between an AR1 130 and an AR2 135. An SIP session is thus established directly between the AR1 130 and the AR2 135.

Similar to sequences where the RM 105 acts as an SIP Controller, where the MN1 120 acts as a caller and intends to initiate communications with the MN2 125 as a callee, as shown in FIG. 4 the MN1 120 transmits to the AR1 130 a Call Setting message to the AR1 130 including the IPha of the MN1 120 and the IPha of the MN2 125. However where the RM 105 acts as an SIP Proxy, the AR1 130 translates the Call Setting message to an SIP Invite request message and then forwards the SIP Invite message to the RM 105. In the SIP Invite message the SIP From header is set to the IPha of the MN1 120 and the SIP To header is set to the IPha of the MN2 125. The IPha and IPra of the MN2 125 and the IPha of the MN2 125 are contained in a payload. When the RM 105 receives the SIP Invite message, it asks the LM 110 for an address to where the message should be forwarded by sending a Query message to the LM 110 to find the current location of the MN2 125. Next, the LM 110 finds the location of the MN2 125 by searching for the IPra of the MN2 125 in a database of the LM 110, by a paging method, or by some other type of method. After the MN2's 125 location is identified, the LM 110 transmits to the RM 105 an Update message including the IPra of the MN2 125. Those skilled in the art will recognize that the Query and Update messages can be realized using an SIP Invite request and an SIP 302 Temporary moved response, respectively, or using other proprietary messages.

After the RM 105 receives the IPra of the MN2 125, the RM 105 sends an SIP Invite request message that identifies the IPra of the MN2 125 and which is routed to the AR2 135. The Invite message includes the IPha and the IPra of both the MN1 120 and the MN2 125. The AR2 135 then translates the received Invite message to a proprietary message called a Call Request and sends it to the MN2 125. The AR2 135 also creates a routing cache entry in an RCT2 135 that records the IPha and IPra of the MN1 120 for use in future address conversions.

When the MN2 125 receives the Call Request message it notifies a call arrival to a user of the MN2 125, such as through a ring tone or vibration, and sends a Call Ringing message to the AR2 135. The AR2 135 then sends an SIP 180 ringing status message to the AR1 130 via the RM 105.

When MN2 125 accepts the call, the MN2 125 sends a Call Response message to the AR2 135. The AR2 135 then transmits an SIP 200 OK message to the AR1 130 via the RM 105. When the AR1 130 receives the SIP 200 OK message, it sends back an SIP ACK message to the AR2 135 and notifies the MN1 120 of completion of the call set up with a Call Ack message. The AR2 135 then sends a Call Ack message to the MN2 125. Finally, the MN1 120 and the MN2 125 commence data transmission between each other through the AR1 130 and the AR2 135. Both the MN1 120 and the MN2 125 use the IPha addresses as source/destination addresses. As described above, the destination address of an IP header in a data packet 160 is translated from an IPha to an IPra at ingress to an AR 130, 135 and then translated back from an IPra to an IPha at egress from an AR 130, 135.

By adapting SIP to facilitate communications between ARs 130, 135 and a NCPF 115, the present invention is thus able to satisfy in a very efficient manner many of the IP² requirements for mobility management. Such requirements include hiding a user's location information; optimizing routing paths and avoiding triangle routing; minimizing packet overhead and avoiding encapsulation; separating network control functions from IP transport functions; and hiding the IP addresses of the RM 105 and the LM 110 from network users.

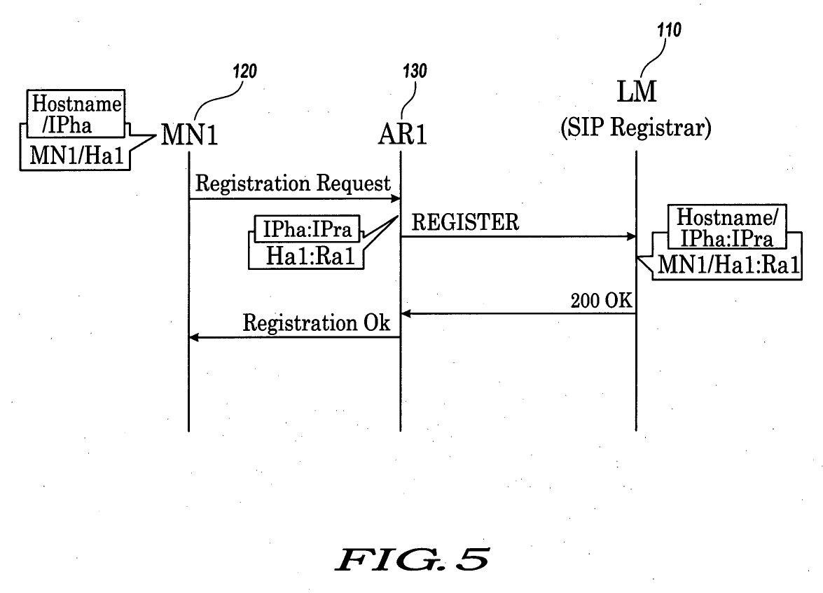

Referring to FIG. 5 there is a message sequence chart illustrating a process of registering a MN1 120 with a NCPF 115 according to an embodiment of the present invention. Registration may occur at various times: when the MN1 120 is first turned on inside of a network that is managed by the NCPF 115, when the MN1 120 is already powered on and moves into range of the NCPF 115, or periodically based on requests from the NCPF 115. Generally the MN1 120 first transmits a Registration Request message to the AR1 130, including the IPha of the MN1 120. The AR1 130 then searches an RCT1 140 for the IPra corresponding to the IPha of the MN1 120. If no entry regarding the IPha of the MN1 120 is registered, the AR1 130 then allocates a new IPra for the MN1 120 and stores the IPha/IPra pair in the RCT1 140. The new registered entry is marked as inactive until the AR1 130 receives an SIP 200 OK message from the LM 110. The AR1 130 then transmits an SIP Register message to the LM 110, including both the IPha and the IPra of the MN1 120. The LM 110 then registers the MN1 120 by including the IPha/IPra pair of the MN1 120 in a location database associated with the LM 110. The LM 110 then transmits an SIP 200 OK message back to the AR1 130, and the AR1 130 transmits a Registration OK message back to the MN1 120. If the AR1 130 doesn't receive an SIP 200 OK message from the LM 110 within a certain time period, the IPha/IPra pair of the MN1 120 in the RCT1 140 will be deleted.

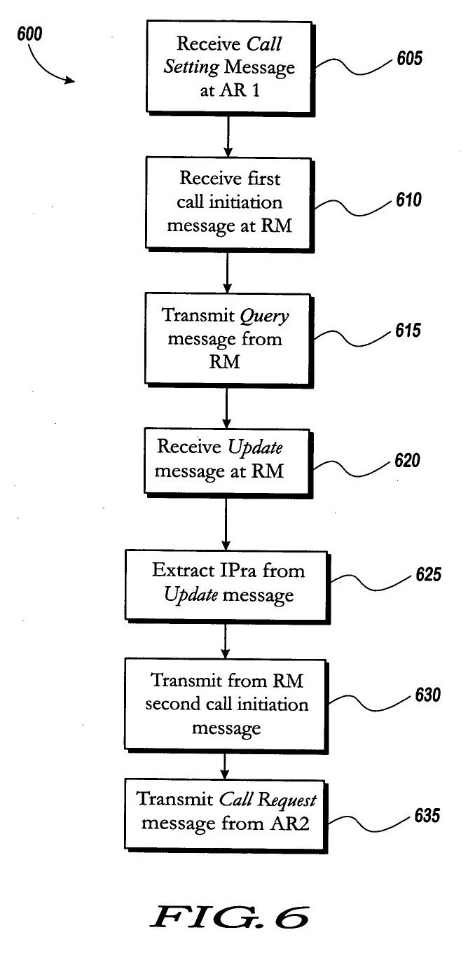

Referring to FIG. 6 there is a general flow diagram illustrating a method 600 for establishing communication between an MN1 120 and an MN2 125 using SIP-based mobility management according to an embodiment of the present invention. As shown in FIGS. 1-4, the MN1 120 is in communication with a AR1 130 and the MN2 125 is in communication with a AR2 135. First, at step 605, the AR1 130 receives from the MN1 120 a Call Setting message. Next, at step 610, a RM 105 receives from the AR1 130, which is acting as an SIP User Agent (UA), a first call initiation message including an IPha of the MN2 125. The RM 105 may act as an SIP Controller, wherein the first call initiation message is a Call Setting message; or the RM 105 may act as an SIP Proxy, wherein the first call initiation message is an SIP Invite message. At step 615, the RM 105 transmits a Query message, which includes the IPha of the MN2 125, to a LM 110 acting as an SIP Registrar. Next, at step 620, the RM 105 receives from the LM 110, in response to the Query message, an Update message including an IPra of the MN2 125 that is used to identify the AR2 135. At step 625, the RM 105 extracts the IPra of the MN2 125 from the Update message. At step 630, the RM 105 transmits to the AR2 135 a second call initiation message that includes the IPra of the MN2 125. At step 635, the AR2 135 transmits to the MN2 125 a Call Request message. Where the MN2 125 is a mobile phone, the Call Request message causes the phone to ring or to otherwise indicate to a user that a call has been received.

In summary, advantages of particular embodiments of the present invention include saving significant development resources and time by adapting an existing protocol to the core network part of an IP system. SIP-based mobility management according to the present invention is efficient because it reuses several SIP schemes, including those concerning message formatting, retransmission mechanisms, and server software. Embodiments of the present invention also satisfy IP² mobility management requirements such as location privacy for MNs 120, 125 and separate IP transport features and network control features. The SIP-based methods and systems of the present invention are also desirable because SIP is an extensible text-based messaging protocol that can integrate Authentication, Authorization and Accounting (AAA) features, Quality of Service (QoS) features, and security negotiation features.

It will be appreciated that embodiments of the invention described herein may be comprised of one or more conventional processors and unique stored program instructions that control the one or more processors to implement, in conjunction with certain non-processsor circuits, some, most, or all of the functions of establishing communications between mobile nodes and of SIP-based mobility management described herein. The non-processor circuits may include, but are not limited to, a radio receiver, a radio transmitter, signal drivers, clock circuits, power source circuits, and user input devices. As such, these functions may be interpreted as steps of a method to perform SIP-based mobility management. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of the present invention. The benefits, advantages, solutions to problems, and any elements that may cause any benefit, advantage, or solution to occur or become more pronounced are not to be construed as critical, required, or essential features or elements of any or all of the claims. The invention is defined solely by the appended claims including any amendments made during the pendency of this application and all equivalents of those claims.

We claim:

1. A method for establishing communication between a first Mobile Node (MN1) and a second Mobile Node (MN2) using Session Initiation Protocol (SIP)-based mobility management, where the MN1 is in communication with a first Access Router (AR1) and the MN2 is in communication with a second Access Router (AR2), the method comprising:
receiving, from the AR1 acting as an SIP User Agent (UA), at a Routing Manager (RM) a first call initiation message including an Internet Protocol host address (IPha) of the MN2;
transmitting a query, which includes the IPha of the MN2, from the RM to a Location Manager (LM) acting as an SIP Registrar;
receiving at the RM from the LM, in response to the query, an Update message including an IP routing address (IPra) of the MN2 that is used to identify the AR2; and
transmitting from the RM to the AR2 a second call initiation message that includes the IPra of the MN2.

2. The method of claim 1 wherein the RM is acting as an SIP Controller and the first call initiation message is a Call Setting message.

3. The method of claim 1 wherein the RM is acting as an SIP Proxy and the first call initiation message is an SIP Invite message.

4. The method of claim 1 further comprising, before receiving at the RM the first call initiation message, receiving at the AR1 from the MN1 a Call Setting message.

5. The method of claim 1 further comprising, after transmitting from the RM the second call initiation message, transmitting from the AR2 to the MN2 a Call Request message.

6. The method of claim 1 wherein the AR1 and the AR2 manage for the MN1 and the MN2, respectively, an IPha/IPra pair in a Routing Cache Table (RCT).

7. The method of claim 1 further comprising extracting at the RM an IPra of either the MN1 or the MN2 from a received Invite, Update, or 200 OK message.

8. The method of claim 1 wherein the LM receives, before receiving the first call initiation message, from the AR1 an SIP Register message including both the IPha and the IPra of the MN1.

9. A Network Control Platform (NCPF) system for establishing communication between a first Mobile Node (MN1) and a second Mobile Node (MN2) using Session Initiation Protocol (SIP)-based mobility management, comprising:
a Routing Manager (RM) adapted to receive a first call initiation message from a first Access Router (AR1), which AR1 acts as an SIP User Agent in communication with the MN1, the message including an Internet Protocol host address (IPha) of the MN2; and
a Location Manager (LM) acting as an SIP Registrar and adapted to receive a query from the RM, the query including the IPha of the MN2, wherein the LM is further adapted to transmit to the RM, in response to the query, an IP routing address (IPra) of the MN2 that is used to identify the AR2.

10. The system of claim 9 wherein the RM is acting as an SIP Controller and the first call initiation message is a Call Setting message.

11. The system of claim 9 wherein the RM is acting as an SIP Proxy and the first call initiation message is an SIP Invite message.

12. The system of claim 9 wherein the AR1 and the AR2 manage for the MN1 and the MN2, respectively, an IPha/IPra pair in a Routing Cache Table (RCT).

13. The system of claim 9 wherein the RM is adapted to extract an IPra of either the MN1 or the MN2 from a received Invite, Update, or 200 OK message.

14. The system of claim 9 wherein the LM is adapted to receive, before receiving the first call initiation message, from the AR1 an SIP Register message including the IPha and the IPra of the MN1.

15. The system of claim 9 wherein the LM is adapted to receive an SIP Register message from the AR1 during a registration process for the MN1 or the MN2.

16. A Network Control Platform (NCPF) system for establishing communication between a first Mobile Node (MN1) and a second Mobile Node (MN2) using Session Initiation Protocol (SIP)-based mobility management, where the MN1 is in communication with a first Access Router (AR1) and the MN2 is in communication with a second Access Router (AR2), the system comprising:
means for receiving, from the AR1 acting as an SIP User Agent (UA), at a Routing Manager (RM) a first call initiation message including an Internet Protocol host address (IPha) of the MN2;
means for transmitting a query, which includes the IPha of the MN2, from the RM to a Location Manager (LM) acting as an SIP Registrar;
means for receiving at the RM from the LM, in response to the query, an Update message including an IP routing address (IPra) of the MN2 that is used to identify the AR2; and
means for transmitting from the RM to the AR2 a second call initiation message, which message includes the IPra of the MN2.
